(19) United States
(12) Patent Application Publication
(10) Pub. No.: US 2013/0266807 A1
(43) Pub. Date: Oct. 10, 2013

(54) METHOD OF MANUFACTURING CARBON FIBER

(71) Applicant: Eiji Kambara, Minato-ku (JP)

(72) Inventor: Eiji Kambara, Minato-ku (JP)

(73) Assignee: SHOWA DENKO K.K., Tokyo (JP)

(21) Appl. No.: 13/994,898

(22) PCT Filed: Dec. 15, 2011
(86) PCT No.: PCT/JP2011/007006

§ 371 Date: Jun. 17, 2013

(30) Foreign Application Priority Data
Dec. 15, 2010 (JP) 2010-279548

(51) Int. Cl. C01B 31/02

(52) U.S. Cl. CPC C01B 31/0293
USPC 428/367; 423/447.3

(57) ABSTRACT

A method of manufacturing carbon fibers, the method comprising the steps of: obtaining a supported catalyst by allowing a main catalyst element such as Fe, Co and Ni and a co-catalyst element such as Ti, V, Cr, W and Mo to be supported by a particulate carrier such as calcium carbonate, calcium hydroxide and calcium oxide; synthesizing fibrous carbons by contacting the supported catalyst with a carbon atom-containing material at synthesis reaction temperature; and then heat treating the resulting fibrous carbons at a temperature of 2000° C. or higher, wherein the particulate carrier comprising a substance which undergoes pyrolysis near the synthetic reaction temperature.

### TECHNICAL FIELD

The present invention relates to a method of manufacturing carbon fibers. More specifically, the present invention relates to a method of manufacturing carbon fibers, the carbon fibers being added to a material such as metal, resin, and ceramics to significantly improve the electrical conductivity and thermal conductivity of the material, in particular the thermal conductivity, and the carbon fibers being suitably used, for example, as a filler to obtain thermally conductive articles such as thermally conductive rolls, heat radiation sheets and the like and thermally conductive fluids such as nanofluid and the like, as an electron emission material for FED (field emission display), as a catalyst carrier for various chemical reactions, as a storage medium for occluding hydrogen, methane, or other gases, or as an electrode material for an electrochemical element such as a battery and capacitor.

### BACKGROUND ART

As thermally conductive fillers, metal particles, and ceramics particles such as alumina, BN, AlN and the like are known. A thermally conductive material can be obtained by compounding a thermally conductive filler with resin, rubber and the like. Such a thermally conductive material is used as a material for a roll used in electrophotographic printers, ink printing devices and the like, and as a material for a heat radiation sheet and the like used to release heat from CPU and the like. Further, nanofluid can be obtained by dispersing a thermally conductive filler in a fluid substance. Nanofluid, development of which is extensively advanced in recent years, is hopefully applied to a refrigerant used in a water-cooling device for CPU or a radiator for an internal combustion engine. Fibrous carbon is thought to be a promising material as a thermally conductive filler because it has high thermal conductivity. However, it has not been put to practical use because a sufficient thermal conductivity conferring effect can not be obtained by the conventional art.
Patent Literature 1: JP 2001-80913 A
Patent Literature 2: U.S. Pat. No. 6,518,218
Patent Literature 3: JP S62-500943 A
Patent Literature 4: JP 2008-174442 A
Patent Literature 5: JP 2010-11173 A
Patent Literature 6: JP 2010-24609 A
Non Patent Literature 1: Chemical Physics Letters 380 (2003) 319-324
Non Patent Literature 2: Chemical Physics Letters 374 (2003) 222-228

### SUMMARY OF THE INVENTION

### Problems to be Resolved by the Invention

For a method of manufacturing fibrous carbons, a method in which it is grown using a catalyst as a nucleus, the so-called chemical vapor deposition method (hereinafter called the CVD method) is known. For the CVD methods, a method in which a catalyst metal supported by a carrier is used, and a method in which a catalyst obtained by pyrolyzing an organometallic complex and the like in a gas phase without using a carrier is used (the fluid vapor phase method) are known.

For the method in which a catalyst generated in a gas phase is used (the fluid vapor phase method), for example, Patent Literature 1 describes a method in which an organometallic complex such as ferrocene is introduced and fluidized in a reaction system along with a carbon atom-containing material such as benzene, and fine metal particles obtained by pyrolyzing the organometallic complex in the reaction system is used as a catalyst to pyrolyze the carbon atom-containing material under hydrogen atmosphere. In the fluid vapor phase method, two reactions: the generation of a catalyst and the carbonization of the carbon atom-containing material undergo simultaneously. Since fibrous carbons obtained by the fluid vapor phase method show many defects in a graphite layer and very low crystallinity, thermal conductivity is not developed when added to resin and the like as a filler. The thermal conductivity of fibrous carbons itself is slightly increased by heat treating the fibrous carbons obtained by the fluid vapor phase method at high temperature. Nonetheless, a sufficient level of thermal conductivity is not conferred on a resin material and the like.

Further, specific surface area is significantly decreased as compared with that before the heat treatment most likely because a carbon crystal lattice plane may be rearranged by the heat treatment at such high temperature. Therefore, it was difficult to obtain fibrous carbons having both a high specific surface area and a high crystallinity. Further, the fibrous carbons obtained by this approach may have a surface showing a hump-like projection (Non-patent Literature 1), or may take a hard aggregated form, causing a problem of dispersion in a resin or liquid. In particular, when used as a liquid dispersion, such aggregated particles not only may cause sedimentation of a filler, but also may promote wear in piping and the like when used as a heat transport fluid.

Meanwhile, the methods in which a supported catalyst is used can be roughly classified into two groups: a method in which a platy carrier is used and a method in which a particulate carrier is used.

The methods in which a platy carrier is used can control a size of a supported catalyst metal in any size by applying various film forming technologies. Therefore, it is widely used in studies at a laboratory level. For example, Nonpatent Literature 2 discloses that a tubular multilayer nanotube and a two layered nanotube having a fiber diameter of about 10 to 20 nm are obtained by using a silicon platy carrier on which a 10 nm aluminum layer, a 1 nm iron layer and a 0.2 nm molybdenum layer are deposited. Further, Patent Literature 2 discloses a catalyst in which a metal comprising a combination of Ni, Cr, Mo and Fe, or a combination of Co, Cu, Fe and Al is supported by a platy carrier using the spattering method and the like, and a method of manufacturing carbon fibers using thereof. In order to use the fibrous carbons obtained by the method in which a platy carrier is used as a filler to be added to a resin and the like, the fibrous carbons are needed to be detached from the platy carrier to collect it. Therefore, in order to accommodate industrial large scale production, this method requires many platy carriers arranged next to each other to achieve a large surface area of the platy carriers, resulting in a low equipment efficiency. Further, many steps are required such as steps of: supporting a catalyst metal onto a platy carrier, synthesizing fibrous carbons and collecting the fibrous carbons from the platy carrier, which is economically disadvantageous. Therefore, the method in which a platy carrier is used has not been put to practical use industrially.

On the other hand, the method in which a particulate carrier is used shows a better equipment efficiency than the method in which a platy carrier is used because the specific surface area of the catalyst carrier is larger in the method in which a particulate carrier is used. In addition, reactors used for various chemical syntheses are applicable to the method in which a particulate carrier is used. Therefore, the method has an advantage that a manufacturing method of batch processing such as the platy carrier method as well as a manufacturing method of continuous processing can be used.

Further, because catalyst lifetime is relatively longer in the case of using a supported catalyst, prolonged reaction is possible as compared with the fluid vapor phase method. As a result, the reaction can be carried out in low temperature. Because this allows carbon fiberization to preferentially undergo while the unwanted pyrolysis of a carbon atom-containing material is suppressed, fibrous carbons having a high crystallinity and a large specific surface area can be efficiently obtained. As a result, even if the heat treatment at high temperature as performed in the fluid vapor phase method is not performed, a high crystallinity (Patent Literature 3) and similar properties as obtained by heat treating fibrous carbons at high temperature in the fluid vapor phase method will be developed.

Accordingly, there has been no actual case in which fibrous carbons synthesized using a particulate supported catalyst are actually subjected to heat treatment at high temperature.

For example, Patent Literature 4 discloses the use of a specific three-component catalyst to improve a catalyst efficiency, and as a result, fibrous carbons with a small amount of impurities are obtained. Although the literature describes that the fibrous carbons obtained can be subjected to heat treatment at high temperature, neither an example actually performed or an effect thereof are disclosed at all. Further, the Example discloses that the use of fibrous carbons synthesized using a catalyst supported on CaCO₃ carrier gives a composite material having high thermal conductivity, but the level of thermal conductivity is not sufficient.

Patent Literatures 5 or 6 disclose that fibrous carbons can be synthesized using a specific three or four component supported catalyst, which is merely a general disclosure. Further, any example actually performed is not described, and any effect thereof is not disclosed.

Thus, an example in which fibrous carbons synthesized using a supported catalyst are actually subjected to heat treatment at high temperature practically does not exist.

The fibrous carbons obtained by the conventional methods do not show a sufficient thermal conductivity conferring effect, and a large amount of fibrous carbons have to be added to rubber and the like in order to obtain desired thermal conductivity. This addition of a large amount of fibrous carbons result in decreased mechanical properties of a composite material such as strength and extensibility. Further, in a liquid dispersion, a high concentration of a filler is required in order to obtain desired thermal conductivity. For this reason, an increased liquid viscosity and decreased fluidity was often caused, and dispersion into a liquid was often difficult in the first place.

In view of these, an object in the present invention is to provide a method of efficiently manufacturing carbon fibers capable of conferring sufficient thermal conductivity when added in a small amount, and having excellent dispersibility into a resin or liquid.

### Means for Solving the Problems

After conducting extensive studies to achieve the above object, the present inventor has found that heat treatment, at high temperature, of fibrous carbons synthesized with a conventional supported catalyst does not significantly improve a thermal conductivity conferring effect, but heat treatment, at high temperature, of fibrous carbons synthesized with a specific supported catalyst does not cause substantially decreased specific surface area and significantly improves the thermal conductivity conferring effect. Further, the present inventor has found that carbon fibers having an unprecedented high thermal conductivity conferring effect are obtained by heat treating fibrous carbons having a specific fiber diameter at high temperature. Based on these findings, the present inventor completed the present invention after further studies.

That is, the present invention comprises the following aspects.

(1) A method of manufacturing carbon fibers, the method comprising the steps of: supporting a metal catalyst on a particulate carrier to obtain a supported catalyst; contacting the supported catalyst with a carbon atom-containing material at synthesis reaction temperature to synthesize fibrous carbons; and then heat treating the resulting fibrous carbons at a temperature of 2000° C. or higher, wherein the particulate carrier comprises a substance which undergoes pyrolysis near the synthesis reaction temperature.
(2) A method of manufacturing carbon fibers, the method comprising the steps of: contacting a supported catalyst with a carbon atom-containing material to synthesize fibrous carbons, the supported catalyst comprising one or more elements selected from the group consisting of alkali metal elements, alkaline earth metal elements, Fe, Co, Ni, Ti, V, Cr, W and Mo, but not substantially comprising any other metal elements; and then heat treating the resulting fibrous carbons at a temperature of 2000° C. or higher.
(3) A method of manufacturing carbon fibers, the method comprising the steps of: contacting a supported catalyst with a carbon atom-containing material to synthesize fibrous carbons, the supported catalyst comprising one or more elements selected from the group consisting of alkali metal elements and alkaline earth metal elements and one element selected from the group consisting of Fe, Co and Ni, but not substantially comprising any other metal elements; and then heat treating the resulting fibrous carbons at a temperature of 2000° C. or higher.
(4) A method of manufacturing carbon fibers, the method comprising the steps of: contacting a supported catalyst with a carbon atom-containing material to synthesize fibrous carbons, the supported catalyst comprising one or more elements selected from the group consisting of alkali metal elements and alkaline earth metal elements, one element selected from the group consisting of Fe, Co and Ni and one element selected from the group consisting of Ti, V, Cr, W and Mo, but not substantially comprising any other metal elements; and then heat treating the resulting fibrous carbons at a temperature of 2000° C. or higher.
(5) A method of manufacturing carbon fibers, the method comprising the steps of: supporting a metal catalyst on a particulate carrier to obtain a supported catalyst, the metal catalyst comprising one element selected from the group consisting of Fe, Co and Ni, and the particulate carrier comprising an alkali metal carbonate or an alkaline earth metal carbonate; contacting the supported catalyst with a carbon atom-containing material to synthesize fibrous carbons having a mean fiber diameter of 5 nm to 70 nm; and then heat treating the resulting fibrous carbons at a temperature of 2000° C. or higher.
(6) A method of manufacturing carbon fibers, the method comprising the steps of: supporting a metal catalyst on a particulate carrier to obtain a supported catalyst, the metal catalyst comprising one element selected from the group consisting of Fe, Co and Ni and one element selected from the group consisting of Ti, V, Cr, W and Mo, and the particulate carrier comprising an alkali metal carbonate or an alkaline earth metal carbonate; contacting the supported catalyst with a carbon atom-containing material to synthesize fibrous carbons having a mean fiber diameter of 5 nm to 70 nm; and then heat treating the resulting fibrous carbons at a temperature of 2000° C. or higher.
(7) A method of manufacturing carbon fibers, the method comprising the step of heat treating fibrous carbons at a temperature of 2000° C. or higher, the fibrous carbons having a mean fiber diameter of 30 nm to 70 nm and synthesized using a particulate supported catalyst.
(8) A method of manufacturing carbon fibers, the method comprising the steps of: supporting a metal catalyst on a particulate carrier to obtain a supported catalyst, the metal catalyst comprising an element Co and one element selected from the group consisting of Ti, V, Cr, W and Mo, the particulate carrier comprising an alkali metal carbonate or an alkaline earth metal carbonate; contacting the supported catalyst with a carbon atom-containing material to synthesize fibrous carbons having a mean fiber diameter of 5 nm to 70 nm at synthesis reaction temperature; and then heat treating the resulting fibrous carbons at a temperature of 2000° C. or higher.
(9) Tubular carbon fibers having a specific surface area of 50 m²/g or more, a mean fiber diameter of 5 nm to 70 nm, and an R value in a Raman spectrum of 0.2 or less.

### Advantageous Effects of the Invention

The present invention can provide tubular carbon fibers showing a high thermal conductivity conferring effect when added in a small amount. The carbon fibers obtained by the manufacturing method in the present invention are easily dispersed uniformly when filled in a metal, resin, ceramics and the like, and can confer high thermal conductivity. An amount to be added also can be reduced. Therefore, the carbon fibers are economical and, in addition, does not cause decreased physical properties such as strength of a resulting composite material. Further, the carbon fibers obtained by the manufacturing method in the present invention are suitably used as a filler in order to obtain thermally conductive articles such as thermally conductive rolls, heat radiation sheets and the like, thermally conductive fluids such as nanofluid and the like, as an electron emission material for FED (field emission display), as a catalyst carrier for various chemical reactions, as a vehicle for occluding hydrogen, methane, or various gases, or as an electrode material for an electrochemical element such as a battery, capacitor and hybrid capacitor.

### EMBODIMENTS FOR CARRYING OUT THE INVENTION

One embodiment of the method of manufacturing carbon fibers according to the present invention comprises the steps of: supporting a metal catalyst on a particulate carrier to obtain a supported catalyst; contacting the supported catalyst with a carbon atom-containing material to synthesize fibrous carbons; and then heat treating the resulting fibrous carbons at a temperature of 2000° C. or higher.

An example of the particulate carriers used for the present invention preferably does not have high thermal stability, for example, preferably undergoes pyrolysis near the synthesis reaction temperature. Preferred particulate carriers can include inorganic salts of alkali metal and inorganic salts of alkaline earth metal. For the inorganic salts, carbonates are the most preferred.

The particulate carrier in the present invention can be selected by measuring a temperature at which pyrolysis starts by differential thermal analysis, but it can be more easily selected by consulting the pyrolysis temperature under Section 4.1: the properties of inorganic compounds, complex compounds, or organic compounds in Kagaku Binran, the 5th revised edition, Basic Vol. I. Specific examples of particulate carriers can include calcium carbonate, calcium hydroxide, calcium oxide, calcium hydride, calcium iodate, calcium selenate, calcium sulfite, strontium hydroxide, strontium nitrate, strontium dihydride, barium hydride, barium selenate, barium bromide, barium peroxide, barium oxalate, sodium hydride and the like, and double salts such as magnesium potassium bis(carbonate). Among these, calcium carbonate is particularly preferred.

There is no particular limitation for a mean particle diameter of the particulate carrier, but it is usually 100 μm or less, preferably 50 μm or less, more preferably 10 μm or less, in particular preferably 5 μm or less. There is no particular limitation for a lower limit of the mean particle diameter of the particulate carrier, but it can be set to any values in view of handling, availability and the like. Note that the mean particle diameter herein is a particle diameter D₅₀ at the 50% cumulative volume.

For the conventional supported catalysts, ceramics particles such as alumina, zirconia, titania, magnesia, zinc oxide, silica, diatomaceous earth and zeolite alumina are used as a carrier. According to the studies by the present inventor, a supported catalyst in which a metal catalyst is supported by these ceramics particles shows a strong holding effect for the metal catalyst, and suppresses aggression and coarsening of the metal catalyst. With a supported catalyst using ceramics particles, fine fibrous carbons are easily produced. As shown in the following Comparative Examples, although such fine fibrous carbons have a high crystallinity, it only shows a slightly improved thermal conductivity conferring effect even if heat treatment at high temperature is performed. On the other hand, since the particulate supported catalyst used for the present invention has poor thermal stability, the holding effect of the metal catalyst appears to be weak. With a supported catalyst and the like using a particulate carrier which undergoes pyrolysis near the synthesis reaction temperature, fibrous carbons having a relatively large fiber diameter can be easily produced. The fibrous carbons having a relatively large fiber diameter show a significantly increased thermal conductivity conferring effect after the heat treatment.

There is no particular limitation for the metal catalyst used in the present invention as long as a synthetic reaction of fibrous carbons is promoted. A metal catalyst may comprise only a main catalyst element, or may comprise a co-catalyst element added to the main catalyst element.

Main catalyst elements can preferably include one element selected from the group consisting of Fe, Co and Ni, and more preferably can include an element Co. Co-catalyst elements can preferably include one element selected from the group consisting of Ti, V, Cr, W and Mo, and more preferably can include an element Mo.

A production rate of fibrous carbons can be improved by adding a co-catalyst element. When the production rate is too fast, a defect easily occurs on a crystal plane of carbon, which may reduce a thermal conductivity conferring effect. Therefore, the species and the amount of the co-catalyst elements are preferably fewer. Further, when two or more main catalyst elements and two or more co-catalyst elements are used, catalyst preparation tends to be complicated. In addition, a degree of improvement of a thermal conductivity conferring effect by heat treatment tends to be small, and the residual amount of impurities in the resulting carbon fibers tend to be larger. Therefore, in the present invention, a metal catalyst having a composition in which one co-catalyst element is added to the main catalyst element is preferred in view of a reaction rate and a production efficiency. In view of improved thermal conductivity, simple catalyst preparation and easy removal of impurities by heat treatment, a metal catalyst comprising only a main catalyst element without adding a co-catalyst element is preferred.

Conventionally, in order to increase a catalyst efficiency and a production rate, several elements are added as co-catalyst elements to reduce impurities in the fibrous carbons produced (see Patent Literatures 4 to 6). In a case where two or more elements are added as co-catalyst elements as described above, a supported catalyst is efficiently prepared by preparing a catalyst liquid containing two or more elements in a high concentration, and impregnating a carrier into the catalyst liquid. However, a supported metal catalyst was actually difficult to be prepared using one catalyst liquid because of pH of the solution and different solubility of each component. Then, a catalytic liquid was usually prepared by adjusting pH, heating and selecting an appropriate solvent in order to dissolve these. However, in a case where the catalyst carrier employed in the present invention is used, the conventional method of preparing a mixed catalyst liquid can not be used because there is limitation for pH, solvent, temperature and the like of the catalyst liquid. Therefore, a uniform supported catalyst can not be obtained in many cases until two or more catalyst liquids containing each component are prepared to repeat a procedure of impregnation into a catalyst carrier and drying several times. For industrial practice, the species of co-catalyst elements to be used are preferably fewer since the efficiency decreases and the cost increases as the number of steps increases.

In the conventional art, a catalyst efficiency is increased and a concentration of residual impurities is reduced by using two or more co-catalyst elements. In contrast, there are few advantages for the use of two or more co-catalyst elements in the present invention since metal impurities from the catalyst are removed by heat treatment at high temperature after the synthesis reaction. Rather, fewer species or the main catalyst element alone is more preferred.

Accordingly, in the present invention, a co-catalyst element for increasing a production rate is not used, or, if any, used in a limited fashion. Further, in the present invention, the fibrous carbons obtained are heat treated at high temperature. This heat treatment can economically give carbon fibers having a high purity, high crystallinity and high thermal conductivity conferring effect.

The adding amount of a co-catalyst element is preferably 30 mol % or less, more preferably 0.5 to 30 mol %, even more preferably 0.5 to 10 mol %, and in particular preferably 0.5 to 5 mol % relative to a main catalyst element, which can give carbon fibers having a high thermal conductivity conferring effect and a small amount of impurities.

There is no particular limitation for methods of preparing a supported catalyst. For example, they include a method comprising: dissolving or dispersing a compound containing a main catalyst element and a compound containing a co-catalyst element in a solvent to obtain a catalyst liquid; mixing the catalyst liquid and a particulate carrier; and then drying the mixture. A dispersing agent or a surfactant may be added to a catalyst liquid. As a surfactant, a cationic surfactant or an anionic surfactant is preferably used. The stability of a main catalyst element and a co-catalyst element in a catalyst liquid is increased by adding a dispersing agent or a surfactant. The concentration of a catalyst element in a catalyst liquid can be suitably selected depending on the species of a solvent, the species a catalyst element and the like. The amount of a catalyst liquid mixed with a particulate carrier is preferably equivalent to the amount of liquid absorbed by the particulate carrier used. The mixture of the catalyst liquid and the particulate carrier is preferably dried at 70 to 150° C. Vacuum drying also may be used for drying. Further, after drying, grinding and classifying are preferably performed for sizing.

For a supported catalyst used for the present invention, preferred is a supported catalyst comprising one or more elements selected from the group consisting of alkali metal elements and alkaline earth metal elements, and one element selected from the group consisting of Fe, Co and Ni, but not substantially comprising any other metal elements; or a supported catalyst comprising one or more elements selected from the group consisting of alkali metal elements and alkaline earth metal elements, one element selected from the group consisting of Fe, Co and Ni, and one element selected from the group consisting of Ti, V, Cr, W and Mo, but not substantially comprising any other metal elements. Further, more specifically, preferred is a supported catalyst obtained by supporting a metal catalyst on a particulate carrier, the metal catalyst comprising one element selected from the group consisting of Fe, Co and Ni, the particulate carrier comprising an alkali metal carbonate or an alkaline earth metal carbonate; or a supported catalyst obtained by supporting a metal catalyst on a particulate carrier, the metal catalyst comprising one element selected from the group consisting of Fe, Co and Ni and one element selected from the group consisting of Ti, V, Cr, W and Mo, the particulate carrier comprising an alkali metal carbonate or an alkaline earth metal carbonate. More preferred is a supported catalyst obtained by supporting a metal catalyst on a particulate carrier, the metal catalyst comprising an element Co and one element selected from the group consisting of Ti, V, Cr, W and Mo, the particulate carrier comprising an alkali metal carbonate or an alkaline earth metal carbonate. Note that “not substantially comprising” means being not more than a detection limit as determined by ICP-AES except for the amount of contaminating elements unavoidable at the time of catalyst preparation. Further, “metal element” herein refers to an element from Group 1 to Group 12 except for H, an element in Group 13 except B, an element in Group 14 except for C, and Sb and Bi in the periodic table.

Next, fibrous carbons are synthesized by contacting a carbon atom-containing material with the supported catalyst at the synthesis reaction temperature. There is no particular limitation for carbon atom-containing materials to be used as long as they serve as a source of carbon atom. For example, they can include alkanes such as methane, ethane, propane, butane, pentane, hexane, heptane, octane and the like; alkenes such as butene, isobutene, butadiene, ethylene, propylene and the like; alkynes such as acetylene and the like; aromatic hydrocarbons such as benzene, toluene, xylene, styrene, naphthalene, anthracene, ethylbenzene, phenanthrene and the like; alcohols such as methanol, ethanol, propanol, butanol and the like; alicyclic hydrocarbons such as cyclopropane, cyclopentane, cyclohexane, cyclopentene, cyclohexene, cyclopentadiene, dicyclopentadiene and the like; other organic compounds such as cumene, formaldehyde, acetaldehyde, acetone and the like; carbon monoxide and carbon dioxide; and the like. These can be used alone or in combination of two or more. Volatile oil, kerosene and the like also can be used as a carbon atom-containing material. Among these, methane, ethane, ethylene, acetylene, benzene, toluene, methanol, ethanol and carbon monoxide are preferred, and in particular, methane, ethane, ethylene, methanol and ethanol are preferred.

A method of contacting a supported catalyst and a carbon atom-containing material in a gas phase can be performed as in the conventional and known vapor deposition method. For example, they include a method comprising: placing the catalyst in a vertical or horizontal reactor heated at a predetermined temperature; and introducing a carbon atom-containing material into the reactor using carrier gas to make a contact. A supported catalyst may be placed in a reactor as in the fixed bed method in which the catalyst is placed on a combustion boat (for example, a quartz combustion boat) in the reactor, or may be placed in a reactor as in the fluidized bed method which allows the catalyst to be fluidized with carrier gas in the reactor. A supported catalyst is preferably reduced by supplying the gas containing reducing gas before supplying a carbon atom-containing material because the supported catalyst may be in an oxidized state. Reduction temperature is preferably 300 to 1000° C., more preferably 500 to 700° C. The time required for reduction varies depending on the scale of a reactor, but it is preferably 10 minutes to 5 hours, more preferably 10 minutes to 60 minutes.

For the carrier gas used to introduce a carbon atom-containing material, reducing gas such as hydrogen gas and the like is preferably used. The amount of the carrier gas can be suitably selected depending on the type of a reactor, but it is preferably 0.1 to 70 parts by mole per 1 part by mole of the carbon atom-containing material. In addition to the reducing gas, inert gas such as nitrogen gas, helium gas, argon gas and the like may be used at the same time. A composition of the gas may be changed in the reaction. The concentration of the reducing gas is preferably 1% by volume or more, more preferably 30% by volume or more, and in particular preferably 85% by volume or more of the total carrier gas. Synthesis reaction temperature is preferably 500 to 1000° C., more preferably 550 to 750° C. When the synthesis reaction temperature is too low, a production efficiency tends to decrease. When the synthesis reaction temperature is too high, the crystallinity of carbon fibers produced tends to be low. Note that the particulate carrier preferably undergoes pyrolysis near the synthesis reaction temperature as described above. Note that “near the synthesis reaction temperature” herein means about ±300° C. of the synthesis reaction temperature.

Next, the fibrous carbons obtained as described above are heat treated. A preferred fibrous carbons to be subjected to heat treatment have a mean fiber diameter of preferably 5 to 100 nm, more preferably 5 to 70 nm, even more preferably 25 to 70 nm, in particular preferably 30 to 70 nm, and most preferably 30 to 50 nm. When the fiber diameter is too large, the crystallinity tends to be too low to achieve a sufficient level of thermal conductivity even after heat treatment. Conversely, when the fiber diameter is too small, the degree of improvement in the thermal conductivity conferring effect by heat treatment may be too small to achieve a sufficient level of thermal conductivity although the crystallinity is high. Note that the mean fiber diameter and the aspect ratio are determined by taking images of about 10 fields at a magnification of about 200,000 times through a transmission electron microscope, and by measuring diameters and aspect ratios of many fibers shown in the fields to calculate the average of those. Further, the preferred fibrous carbons to be subjected to heat treatment have a specific surface area of preferably 20 to 400 m²/g, more preferably 30 to 350 m²/g, even more preferably 40 to 200 m²/g, and in particular preferably 40 to 100 m²/g. Note that the specific surface area can be determined by the BET method using nitrogen adsorption.

The conventional heat treated fibrous carbons did not show a significantly improved thermal conductivity conferring effect. However, according to the present invention, the thermal conductivity conferring effect is significantly improved by heat treatment. Particularly, the heat treatment of the fibrous carbons having a fiber diameter and a specific surface area in the ranges described above can significantly improve a thermal conductivity conferring effect and can reduce the residual amount of impurities. Therefore it is particularly preferred since the obtained carbon fibers showing a higher thermal conductivity conferring effect and a smaller residual amount of impurities than the conventional carbon fibers can be easily obtained.

The heat treatment is usually performed at a temperature of 2000° C. or more, preferably 2000 to 3500° C., more preferably 2500 to 3000° C. The heat treatment may be performed at high temperature from the beginning, or may be performed by increasing temperature stepwise. In the heat treatment in which temperature is increased stepwise, the first step is usually performed at 800 to 1500° C., and the second step is performed at 2000 to 3500° C. The heat treatment is preferably performed under an atmosphere of inert gas such as helium and argon.

The change from the specific surface area before the heat treatment to the specific surface area after the heat treatment is preferred to be small. Specifically, the difference between the specific surface areas before and after the heat treatment is preferably 20% or less, more preferably 10% or less, and most preferably 5% or less of the specific surface area before the heat treatment.

The residual catalyst and metal impurities derived from the catalyst carrier are sublimated by the heat treatment described above, reducing the amount of residual impurities in carbon fibers. In the carbon fibers according to the present invention, the concentration of residual metals is preferably 1000 ppm or less, more preferably 100 ppm or less, even more preferably 10 ppm or less. Because impurities can be removed by the heat treatment at high temperature as described above, there is no particular limitation for the amount of the catalyst remaining in the fibrous carbons and the amount of residual impurities derived from the catalyst carrier immediately after synthesis.

A preferred embodiment of the carbon fibers according to the present invention has an R value in Raman spectroscopy of preferably 0.3 or less, more preferably 0.2 or less, and in particular preferably 0.15 or less. A smaller R value shows a greater degree of growth of a graphite layer in the carbon fibers. The carbon fibers having an R value satisfying the above ranges confer a higher thermal conductivity on a resin and the like when filled in the resin and the like. Note that an R value is an intensity ratio, I_{D}/I_{G}, of the peak intensity (I_{D}) near 1360 cm⁻¹ and the peak intensity (I_{G}) near 1580 cm⁻¹ as determined by Raman spectroscopy. I_{D} and I_{G} were measured with a Kaiser Series 5000 under the condition of an excitation wavelength of 532 nm.

A preferred embodiment of the carbon fibers according to the present invention has a mean fiber diameter of preferably 5 to 100 nm, more preferably 5 to 70 nm, even more preferably 25 to 70 nm, and in particular preferably 30 to 50 nm. Further, a preferred embodiment of the carbon fibers according to the present invention has an aspect ratio, that is a ratio of a fiber length/a fiber diameter, of preferably 5 to 1000.

A preferred embodiment of the carbon fibers according to the present invention has a low limit of the specific surface area of preferably 20 m²/g, more preferably 30 m²/g, even more preferably 40 m²/g, and in particular preferably 50 m²/g. There is no particular limitation for an upper limit of the specific surface area, but it is preferably 400 m²/g, and more preferably 350 m²/g.

A preferred embodiment of the carbon fibers according to the present invention has a graphite layer approximately parallel to the fiber axis. Note that “approximately parallel” as used in the present invention means that a tilt angle of a graphite layer and the fiber axis is about ±15 degrees or less. Further, a preferred embodiment of the carbon fibers according to the present invention has a so-called tubular structure having empty space in the center of the fiber. The empty space may be continued in a longitudinal direction of the fiber, or may be discontinued. There is no particular limitation for the ratio (d₀/d) of the inner diameter of the empty space d₀ and the fiber diameter d, but d₀/d is preferably 0.1 to 0.8, more preferably 0.1 to 0.6.

The carbon fibers according to the present invention has excellent dispersibility in a matrix such as a resin, metal, ceramics and the like. Therefore, a composite material having high thermal conductivity can be obtained by making the carbon fibers contained in a resin and the like. In particular, when compounded in a resin, a resin composite material can be obtained which shows an excellent effect, i.e., thermal conductivity similar to that obtained by the conventional fibrous carbons by the loading amount of ½ to ⅓ or less by mass relative to the loading amount of the conventional fibrous carbons.

Ceramics to which the carbon fibers according to the present invention are added include, for example, aluminium oxide, mullite, silicon oxide, zirconium oxide, silicon carbide, silicon nitride and the like. Metals to which the carbon fibers according to the present invention are added include, for example, gold, silver, aluminium, iron, magnesium, lead, copper, tungsten, titanium, niobium, hafnium, and alloys and mixtures thereof.

Resins to which the carbon fibers according to the present invention are added include thermoplastic resins and thermosetting resins. For the thermoplastic resins, a resin to which a thermoplastic elastomer or a rubber component is added to improve impact resistance can also be used. Other various resin additives can be compounded in a resin composition in which the carbon fibers according to the present invention are dispersed, in a range where the performance and function of the resin composition are not hindered. Resin additives include, for example, colorants, plasticizers, lubricants, thermostabilizers, light stabilizers, ultraviolet absorbers, fillers, foaming agents, flame retardants, anticorrosives, antioxidants and the like. These resin additives are preferably compounded at the final step of preparing a resin composition.

Liquid substances in which the carbon fibers according to the present invention are dispersed suitably include a thermally conductive fluid in which the carbon fibers are dispersed in water, alcohol, ethylene glycol and the like; a thermally conductive coating material in which the carbon fibers are dispersed in a liquid along with a coating material and a binder resin; a liquid dispersion for forming a film.

### EXAMPLES

Examples in the present invention are shown below to illustrate the present invention more specifically. Note that these are merely examples for illustration, and the present invention is not limited to those in any way.

Physical properties and the like were measured by the following ways.

### [Impurity Concentration]

In a quartz beaker, 0.1 g of carbon fiber was precisely weighed to perform nitrosulfuric acid decomposition. After cooling, the volume was brought to 50 ml. This solution was suitably diluted, and then subjected to quantification of each element with an ICP-AES (Atomic Emission Spectrometer) using a CCD multi-element simultaneous ICP emission spectrophotometer (VARIAN: VISTA-PRO) at a high frequency output of 1200 W for a measuring time of 5 seconds.

### [Thermal Conductivity]

Carbon fiber and a cycloolefin polymer (ZEON CORPORATION, ZEONOR 1420R) were weighed to give a 5% by mass concentration of the carbon fiber in a composite material, and kneaded for 10 minutes at 270° C. and 80 rpm using a LABOPLASTOMILL (TOYO SEIKI SEISAKU-SYO, LTD, 30C150). The kneaded product was heat pressed at 280° C. and 50 Mpa for 60 seconds to give four 20 mm×20 mm×2 mm plates. Thermal conductivity was measured with a Keithley HotDisk TPS2500 by the hotdisk method.

### Example 1

A catalyst liquid was prepared by dissolving 0.99 part by mass of cobalt (II) nitrate hexahydrate and 0.006 part by mass of hexaammonium heptamolybdate in 1 part by mass of methanol. The catalyst liquid was mixed with 1 part by mass of calcium carbonate (UBE MATERIAL INDUSTRIES LTD.: CS.3N-A30), and then vacuum dried at 120° C. for 16 hours to obtain a supported catalyst.

The supported catalyst was weighed into a quartz boat; the quartz boat was placed in a quartz tubular reactor; and then the reactor was sealed. The atmosphere in the reactor was replaced with nitrogen gas, and then the reactor was heated from room temperature to 690° C. in 30 minutes while flowing nitrogen gas. While the temperature was maintained at 690° C., nitrogen gas was switched to a mixed gas of nitrogen gas 50 parts by volume and ethylene gas 50 parts by volume, which was flowed into the reactor for 60 minutes to allow the vapor deposition reaction. The mixed gas was switched to nitrogen gas; the atmosphere in the reactor was replaced with nitrogen gas; and then the reactor was cooled down to room temperature. The reactor was opened and the quartz boat was taken out. Fibrous carbon grown using the supported catalyst as a nucleus was obtained. The fibrous carbon has a tubular structure with a multi-layered shell. A BET specific surface area S_{SA} was measured to be 90 m²/g.

The fibrous carbon obtained was heat treated at 2800° C. for 20 minutes under the flow of argon gas to obtain carbon fiber. The carbon fiber obtained was found to have a BET specific surface area of 90 of metal impurities derived from the supported catalyst was not more than the detection limit (100 ppm) for each. Further, the thermal conductivity of the composite material obtained by kneading 5% by mass of the obtained carbon fiber in the cycloolefin polymer showed a very high value of 0.52 W/mK. These results are shown together in Table 1.

### Comparative Example 1

Carbon fiber was obtained by the same method as in Example 1 except that the amount of hexaammonium heptamolybdate was changed to 0.06 part by mass, and the heat treatment at high temperature was not performed. The results are shown in Table 1. The thermal conductivity was as low as 0.41 W/mK, and further, the total amount of metal impurities was as high as about 6%.

### Comparative Example 2

Preparation of a catalyst liquid was tried by the same method as in Example 1 except that chromium nitrate was further added in the amount equivalent to 10% by mol of cobalt nitrates, but it appeared to be difficult and appeared to take a long time to dissolve all the components. Therefore, a liquid in which a metal compound was dissolved was prepared for each. These liquids were added to 1 part by mass of calcium carbonate (UBE MATERIAL INDUSTRIES LTD.: CS.3N-A30) in sequence and mixed, which was then vacuum dried at 120° C. for 16 hours to obtain a supported catalyst. Carbon fiber was obtained by the same method as in Comparative Example 1 except that the obtained supported catalyst was used. The results are shown in Table 1. The catalytic efficiency was improved, that is the amount of residual impurities was decreased, as compared with that in Comparative Example 1, but the R value in a Raman spectrum was found to be large while the crystallinity was found to be low. The thermal conductivity was significantly lower than that in Comparative Example 1.

### Comparative Example 3

Carbon fiber was obtained by the same method as in Comparative Example 1 except that 1.8 part by mass of ferric (III) nitrate nonahydrate was substituted for cobalt nitrate, and fumed alumina (DEGUSSA, AluminumOxideC) was substituted for calcium carbonate. The results are shown in Table 1.

### Comparative Example 4

The carbon fiber having a specific surface area of 225 m²/g obtained in Comparative Example 3 was heat treated by the same method as in Example 1. The results are shown in Table 1.

### Comparative Example 5

In accordance with the method described in Patent Literature 1, carbon fiber was synthesized by the gas fluidized process. The carbon fiber was heat treated by the same method as in Example 1. The results are shown in Table 1.

### [Table 1]

TABLE 1

| | Ex. | Comp. Ex. | | | | |
|---|---|---|---|---|---|---|
| | 1 | 1 | 2 | 3 | 4 | 5 |
| Particulate Carrier | CaCO₃ | CaCO₃ | CaCO₃ | Al₂O₃ | Al₂O₃ | None |
| Main Catalyst | Co | Co | Co | Fe | Fe | Fe |
| Co-Catalyst | Mo | Mo | Mo, Cr | Mo | Mo | S |
| S_{SA} [m²/g] before heat treatment | 90 | 90 | 90 | 225 | 225 | 25 |
| Heat treatment | Exec | Unexec | Unexec | Unexec | Exec | Exec |
| Properties of carbon fiber | | | | | | |
| Raman R value | 0.13 | 0.48 | 0.63 | 1.20 | 0.30 | 0.17 |
| BET specific surface area [m²/g] | 90 | 90 | 90 | 225 | 225 | 13 |
| Mean fiber diameter [nm] | 40 | 40 | 40 | 20 | 20 | 150 |
| Thermal conductivity [W/mK] | 0.52 | 0.41 | 0.38 | 0.30 | 0.35 | 0.34 |
| Impurity concentration [%] | <0.01 | 6 | 4 | 5 | <0.01 | <0.01 |

These results show that the carbon fiber (Example 1) obtained by the manufacturing method in the present invention can confer good dispersibility and sufficient thermal conductivity when added in a small amount as compared with the fibrous carbons obtained by the conventional method.

1.-9. (canceled)

10. A method of manufacturing carbon fibers, the method comprising the steps of:
supporting a metal catalyst on a particulate carrier to obtain a supported catalyst;
contacting the supported catalyst with a carbon atom-containing material at synthesis reaction temperature to synthesize fibrous carbons; and then heat treating the resulting fibrous carbons at a temperature of 2000° C. or higher,
wherein the particulate carrier comprises a substance which undergoes pyrolysis near the synthesis reaction temperature.

11. A method of manufacturing carbon fibers, the method comprising the steps of:
contacting a supported catalyst with a carbon atom-containing material to synthesize fibrous carbons, the supported catalyst comprising one or more elements selected from the group consisting of alkali metal elements, alkaline earth metal elements, Fe, Co, Ni, Ti, V, Cr, W and Mo, but not substantially comprising any other metal elements;
and then heat treating the resulting fibrous carbons at a temperature of 2000° C. or higher.

12. The method of manufacturing carbon fibers according to claim 11, wherein the supported catalyst is one comprising one or more elements selected from the group consisting of alkali metal elements and alkaline earth metal elements and one element selected from the group consisting of Fe, Co and Ni, but not substantially comprising any other metal elements.

13. The method of manufacturing carbon fibers according to claim 11, wherein the supported catalyst is one comprising one or more elements selected from the group consisting of alkali metal elements and alkaline earth metal elements, one element selected from the group consisting of Fe, Co and Ni and one element selected from the group consisting of Ti, V, Cr, W and Mo, but not substantially comprising any other metal elements.

14. A method of manufacturing carbon fibers, the method comprising the steps of:
supporting a metal catalyst on a particulate carrier to obtain a supported catalyst, the metal catalyst comprising one element selected from the group consisting of Fe, Co and Ni, the particulate carrier comprising an alkali metal carbonate or an alkaline earth metal carbonate; contacting the supported catalyst with a carbon atom-containing material to synthesize fibrous carbons having a mean fiber diameter of 5 nm to 70 nm;
and then heat treating the resulting fibrous carbons at a temperature of 2000° C. or higher.

15. The method of manufacturing carbon fibers according to claim 14, wherein the metal catalyst is one comprising one element selected from the group consisting of Fe, Co and Ni and one element selected from the group consisting of Ti, V, Cr, W and Mo.

16. A method of manufacturing carbon fibers, the method comprising the step of heat treating fibrous carbons at a temperature of 2000° C. or higher, the fibrous carbons having a mean fiber diameter of 30 nm to 70 nm and synthesized using a particulate supported catalyst.

17. The method of manufacturing carbon fibers according to claim 14, wherein the metal catalyst is one comprising an element Co and one element selected from the group consisting of Ti, V, Cr, W and Mo.

18. A tubular carbon fibers having a specific surface area of 50 m²/g or more, a mean fiber diameter of 5 nm to 70 nm and an R value in a Raman spectrum of 0.2 or less.
